(19) United States
(12) Patent Application Publication
(10) Pub. No.: US 2023/0262510 A1
(43) Pub. Date: Aug. 17, 2023

(54) TRANSMISSION COVERAGE TECHNIQUES

(71) Applicant: QUALCOMM INCORPORATED, San Diego, CA (US)

(72) Inventors: Kapil GULATI, Belle Mead, NJ (US); Junyi LI, Fairless Hills, PA (US); Hui GUO, Beijing (CN); Sourjya DUTTA, San Diego, CA (US); Shuanshuan WU, San Diego, CA (US)

(21) Appl. No.: 18/003,749

(22) PCT Filed: Aug. 26, 2020
(86) PCT No.: PCT/CN2020/111267

§ 371 Date: Dec. 29, 2022

(51) Int. Cl. H04W 28/02

(52) U.S. Cl. CPC H04W 28/0226; H04W 28/0268

(57) ABSTRACT

Methods, systems, and devices for wireless communications are described. A user equipment (UE) may receive, at a second protocol layer of the UE and from a first protocol layer of the UE, the second protocol layer being lower than the first protocol layer, an indication of one or more quality of service parameters associated with a data packet to be transmitted by the UE. The UE may identify, from the one or more quality of service parameters, directional coverage information associated with the data packet, the directional coverage information indicative of one or more transmission directions in which the data packet is to be transmitted. The UE may transmit the data packet in accordance with at least the directional coverage information of the one or more quality of service parameters.

### CROSS REFERENCE

The present Application is a 371 national stage filing of International PCT Application No. PCT/CN2020/111267 by Gulati et al. entitled “TRANSMISSION COVERAGE TECHNIQUES,” filed Aug. 26, 2020, which is assigned to the assignee hereof, and which is expressly incorporated by reference in its entirety herein.

### FIELD OF TECHNOLOGY

The following relates to wireless communications, including transmission coverage techniques.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). In some wireless communications systems (e.g., vehicle-to-everything (V2X) systems), a UE may be configured to transmit data omni-directionally, which may result in relatively inefficient communications. For example, the UE may fail to successfully transmit the data, the UE may allocate power relatively inefficiently, or both.

### SUMMARY

The described techniques relate to improved methods, systems, devices, and apparatuses that support transmission coverage techniques. Generally, the described techniques enable a user equipment (UE) to implement directional coverage for data transmissions in a wireless communications system. For example, the UE may identify one or more parameters (e.g., quality of service (QoS) parameters) associated with a data packet to be transmitted by the UE. In some examples, a first protocol layer of the UE (e.g., an application layer) may indicate the parameters to a second protocol layer of the UE (e.g., an access layer of the UE). The UE may identify directional coverage information for the data packet based on the one or more parameters. The directional coverage information may indicate one or more transmission directions in which the data packet is to be transmitted. For example, the directional coverage information may indicate one or more directions for transmission the data packet (e.g., directions relative to the motion of the UE, directions relative to reference directions), one or more weighting factors for the directions, or a combination thereof. The UE may transmit the data packet in accordance with the parameters. For example, the UE may transmit the data packet using the directional coverage information (e.g., the coverage area of the data transmission may be biased in a relatively higher priority direction). Such techniques may result in one or more potential advantages. For example, the UE may be enabled to transmit data directionally and allocate power to one or more antennas in accordance with the set of QoS parameters, which may result in more efficient power allocation at the UE, ensure that the data is successfully received by other devices in the system, or both, among other advantages.

A method of wireless communications at a UE is described. The method may include receiving, at a second protocol layer of the UE and from a first protocol layer of the UE, the second protocol layer being lower than the first protocol layer, an indication of one or more quality of service parameters associated with a data packet to be transmitted by the UE, identifying, from the one or more quality of service parameters, directional coverage information associated with the data packet, the directional coverage information indicative of one or more transmission directions in which the data packet is to be transmitted, and transmitting the data packet in accordance with at least the directional coverage information of the one or more quality of service parameters.

An apparatus for wireless communications at a UE is described. The apparatus may include a processor, memory coupled with the processor, and instructions stored in the memory. The instructions may be executable by the processor to cause the apparatus to receive, at a second protocol layer of the UE and from a first protocol layer of the UE, the second protocol layer being lower than the first protocol layer, an indication of one or more quality of service parameters associated with a data packet to be transmitted by the UE, identify, from the one or more quality of service parameters, directional coverage information associated with the data packet, the directional coverage information indicative of one or more transmission directions in which the data packet is to be transmitted, and transmit the data packet in accordance with at least the directional coverage information of the one or more quality of service parameters.

Another apparatus for wireless communications at a UE is described. The apparatus may include means for receiving, at a second protocol layer of the UE and from a first protocol layer of the UE, the second protocol layer being lower than the first protocol layer, an indication of one or more quality of service parameters associated with a data packet to be transmitted by the UE, identifying, from the one or more quality of service parameters, directional coverage information associated with the data packet, the directional coverage information indicative of one or more transmission directions in which the data packet is to be transmitted, and transmitting the data packet in accordance with at least the directional coverage information of the one or more quality of service parameters.

A non-transitory computer-readable medium storing code for wireless communications at a UE is described. The code may include instructions executable by a processor to receive, at a second protocol layer of the UE and from a first protocol layer of the UE, the second protocol layer being lower than the first protocol layer, an indication of one or more quality of service parameters associated with a data packet to be transmitted by the UE, identify, from the one or more quality of service parameters, directional coverage information associated with the data packet, the directional coverage information indicative of one or more transmission directions in which the data packet is to be transmitted, and transmit the data packet in accordance with at least the directional coverage information of the one or more quality of service parameters.

### BRIEF DESCRIPTION OF THE DRAWINGS

FIG. 1 illustrates an example of a system for wireless communications that supports transmission coverage techniques in accordance with aspects of the present disclosure.

FIG. 2 illustrates an example of a wireless communications system that supports transmission coverage techniques in accordance with aspects of the present disclosure.

FIG. 3 illustrates an example of a block diagram that supports transmission coverage techniques in accordance with aspects of the present disclosure.

FIG. 4 illustrates an example of a process flow that supports transmission coverage techniques in accordance with aspects of the present disclosure.

FIGS. 5 and 6 show block diagrams of devices that support transmission coverage techniques in accordance with aspects of the present disclosure.

FIG. 7 shows a block diagram of a communications manager that supports transmission coverage techniques in accordance with aspects of the present disclosure.

FIG. 8 shows a diagram of a system including a device that supports transmission coverage techniques in accordance with aspects of the present disclosure.

FIGS. 9 and 10 show flowcharts illustrating methods that support transmission coverage techniques in accordance with aspects of the present disclosure.

### DETAILED DESCRIPTION

In some wireless communications systems, devices may communicate data with other devices. For example, a UE (e.g., a vehicle) may communicate data packets with other UEs via sidelink communications in a wireless communications system (e.g., a vehicle-to-everything (V2X) system). In some cases, data packets may include information that is relatively more relevant for some directions. As an illustrative example, a UE may send a V2X data packet indicating an object detected in front of the UE. Such information may be relatively more relevant for UEs behind the UE rather than UEs in front of the UE. However, the UE may be configured to transmit such data packets omni-directionally, which may result in relatively inefficient communications (e.g., the UE may fail to successfully transmit the data, the UE may allocate power relatively inefficiently for data transmission, or both).

The techniques described herein may enable devices in a wireless communications system to implement directional coverage for data transmissions. For example, a UE may identify one or more parameters associated with a data packet to be transmitted by the UE. In some examples, a first protocol layer of the UE (e.g., an application layer) may indicate the parameters to a second protocol layer of the UE (e.g., an access layer of the UE). As an illustrative example, an application layer may indicate quality of service (QoS) parameters associated with a data packet (e.g., a range parameter for V2X groupcast), QoS parameters associated with a data flow (e.g., a resource type, a priority level, a packet delay budget, a packet error rate, etc.), or a combination thereof, among other examples of parameters. The parameters may include directional coverage information associated with the data packet and/or the data flow. For example, the parameters may indicate a direction to transmit the data packet with respect to the direction of motion of the UE (e.g., in the direction of motion, perpendicular to the direction of motion, opposite the direction of motion, or a combination thereof). Additionally or alternatively, the parameters may indicate a direction to transmit the data packet with respect to a frame of reference (e.g., reference directions such as north, east, west, south, or a combination thereof). In some examples, the directional coverage information may include a combination of directions, one or more weighting factors (e.g., each weighting factor indicating a relative importance of a respective direction), or both.

In some examples, the UE may assign the data packet to a data flow (e.g., a QoS flow) based on a mapping between the QoS parameters indicated by the application layer (e.g., including the directionality coverage information) to a set of configured QoS flows (e.g., the UE may select a QoS flow with a different set of parameters in accordance with the mapping). The UE may determine a radio bearer for transmitting the data packet based on the selected data flow. The UE may transmit the data packet in accordance with the parameters. For example, the UE may transmit the data packet using the directional coverage information (e.g., the coverage area of the data transmission may be biased in a relatively higher priority direction in accordance with the parameters). In some examples, the UE may identify one or more transmit antennas and/or a transmit precoder (e.g., a power split over a selected set of transmit antennas) in accordance with the directional coverage information. Additionally or alternatively, the UE may send one or more retransmissions of the data packet in accordance with one or more parameters (e.g., the UE may send each retransmission using a respective set of parameters based on the directionality coverage information) as described herein.

Such techniques may result in one or more potential advantages. For example, the UE may be enabled to transmit data directionally and allocate power to one or more antennas in accordance with the set of QoS parameters, which may result in more efficient power allocation at the UE, ensure that the data is successfully received by other devices in the system, or both, among other advantages.

Aspects of the disclosure are initially described in the context of wireless communications systems. Aspects of the disclosure are then described in the context of block diagrams and process flows. Aspects of the disclosure are further illustrated by and described with reference to apparatus diagrams, system diagrams, and flowcharts that relate to transmission coverage techniques.

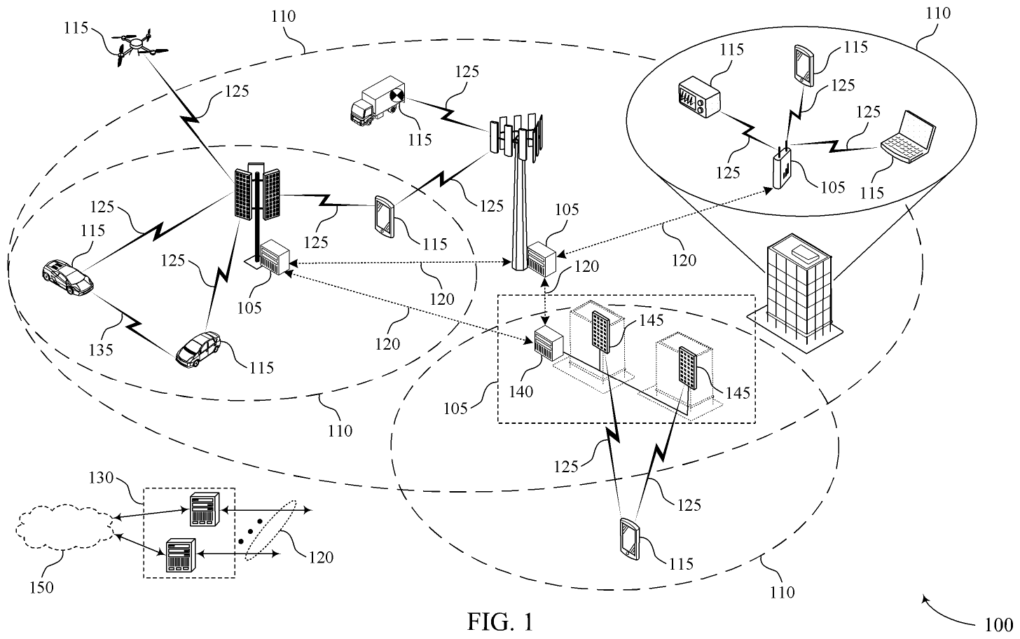

FIG. 1 illustrates an example of a wireless communications system 100 that supports transmission coverage techniques in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V₂X) communications, vehicle-to-vehicle (V2V) communications, or some combination of these. A vehicle may signal information related to traffic conditions, signal scheduling, weather, safety, emergencies, or any other information relevant to a V₂X system. In some examples, vehicles in a V₂X system may communicate with roadside infrastructure, such as roadside units, or with the network via one or more network nodes (e.g., base stations 105) using vehicle-to-network (V₂N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D₂D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The wireless communications system 100 may support sidelink communications between devices. For example, a UE 115 may communicate with other UEs 115 via communication links 135. The UEs 115 may be examples of vehicles or vulnerable road users (VRUs), among other examples of wireless devices. The UEs 115 may communicate one or more data packets via sidelink transmissions (e.g., a vehicle may send data transmissions directionally in accordance with one or more QoS parameters).

The techniques described herein may enable devices in the wireless communications system 100 to implement directional coverage for data transmissions. For example, a UE 115 may identify one or more parameters associated with a data packet to be transmitted by the UE 115. In some examples, a first protocol layer of the UE 115 (e.g., an application layer) may indicate the parameters to a second protocol layer of the UE 115 (e.g., an access layer). As an illustrative example, an application layer may indicate QoS parameters associated with a data packet (e.g., a range parameter for V₂X groupcast), QoS parameters associated with a data flow (e.g., a resource type, a priority level, a packet delay budget, a packet error rate, etc.), or a combination thereof, among other examples of parameters. The parameters may include directional coverage information associated with the data packet and/or the data flow. For example, the parameters may indicate a direction to transmit the data packet with respect to the direction of motion of the UE 115 (e.g., in the direction of motion, perpendicular to the direction of motion, opposite the direction of motion, or a combination thereof). Additionally or alternatively, the parameters may indicate a direction to transmit the data packet with respect to a frame of reference (e.g., reference directions such as north, east, west, south, or a combination thereof). In some examples, the directional coverage information may include a combination of directions, one or more weighting factors (e.g., each weighting factor indicating a relative importance of a respective direction), or a combination thereof.

In some examples, the UE 115 may assign the data packet to a data flow (e.g., a QoS flow) based on a mapping between the QoS parameters indicated by the application layer (e.g., including the directionality coverage information) to a set of configured QoS flows (e.g., the UE 115 may select a QoS flow with a different set of parameters in accordance with the mapping). The UE 115 may determine a radio bearer for transmitting the data packet based on the selected data flow. The UE 115 may transmit the data packet in accordance with the parameters. For example, the UE 115 may transmit the data packet using the directional coverage information (e.g., the coverage area of the data transmission may be biased in a relatively higher priority direction in accordance with the parameters). In some examples, the UE 115 may identify one or more transmit antennas and/or a transmit precoder (e.g., a power split over a selected set of transmit antennas) in accordance with the directional coverage information. Additionally or alternatively, the UE 115 may send one or more retransmissions of the data packet in accordance with one or more parameters (e.g., the UE 115 may send each retransmission using a respective set of parameters based on the directionality coverage information) as described herein.

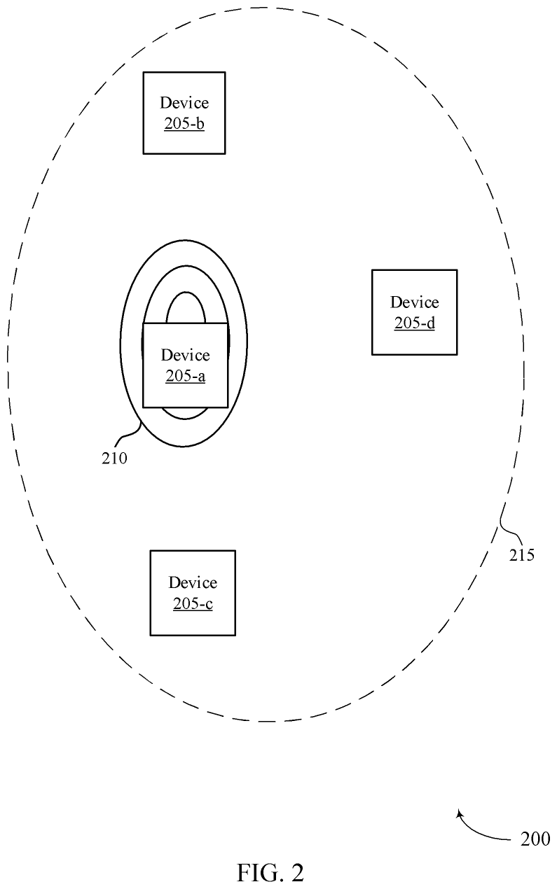

FIG. 2 illustrates an example of a wireless communications system 200 that supports transmission coverage techniques in accordance with aspects of the present disclosure. In some examples, the wireless communications system 200 may implement aspects of wireless communications system 100. For example, the wireless communications system 200 may include devices 205, which may be examples of UEs 115 (e.g., vehicles) as described with reference to FIG. 1. Generally, the wireless communications system 200 illustrates an example of the devices 205 implementing directional information (e.g., a transmission coverage bias) for sidelink communications.

The devices 205 may communicate using sidelink transmissions in the coverage area 215, which may be an example of a coverage area 110 as described with reference to FIG. 1. In some examples, the devices 205 may be examples of UEs, vehicles, VRUs, pedestrian devices, drones, roadside units (RSUs), or any combination thereof, among other examples of wireless devices. As an illustrative example, the device 205-a may be a vehicle communicating data with other vehicles (e.g., the device 205-b, the device 205-c, and the device 205-d) using sidelink communications in a V₂X communications system.

In some examples, the devices 205 may include one or more TRPs. A TRP may be an example of an array of one or more antennas that is capable of transmission of wireless communications (e.g., transmit antennas for sending the signal 210) and reception of the wireless communications. In some examples, a TRP of a device 205 may correspond to a coverage area for communications. For example, a TRP located on a front bumper or a front rooftop of a vehicle may result in a transmission coverage area that is relatively larger to the front or sides (e.g., from 90 degrees to 270 degrees on an azimuth plot, among other examples of values and coverage area patterns) of the vehicle, a TRP located on a rear rooftop or a rear bumper of a vehicle may result in a transmission coverage area that is relatively larger to the rear and/or sides of the vehicle, etc. In some examples, a device 205 may include multiple TRPs for communications in the wireless communications system 200. For example, the device 205-a may include multiple TRPs and may send the signal 210 using the multiple TRPs. By using multiple TRPs to transmit the signal 210, the device 205-a may realize relatively higher coverage area (e.g., the device 205-a may be enabled with a 360 degree coverage area using the multiple TRPs), among other advantages.

The device 205-a may identify a data packet to communicate to one or more of the other devices 205. For example, an application of the device 205-a may generate a data packet for sidelink communications with the other devices 205. In some examples, data packets (e.g., V₂X packets) may be relatively more relevant for communication in some directions than other directions. That is, a data packet may be associated with a directionality in which the data information in the packet is more relevant than other directions. As an illustrative example, device 205-a may exchange messages with the devices 205-b, 205-c, and 205-d indicating a forward collision warning. For instance, the device 205-a may use sensor information to determine a possible collision with the device 205-b, and the device 205-a may indicate the possible collision via a sidelink message. The sidelink message may be relatively more relevant for the direction towards the device 205-b (e.g., the forward or approaching direction) compared to the directions towards the device 205-c (e.g., a backward or receding direction) or the device 205-d (e.g., a side direction). For example, the device 205-b may take an action (e.g., a lane change, an increase in speed, etc.) using the collision warning, whereas such information may not be used by the devices 205-c or 205-d.

As another illustrative example, the device 205-b may detect objects in the front of the device 205-b and may attempt to share sensor information via a sidelink message indicating the detected objects. Such information may be relatively more relevant for transmission in the backwards direction (e.g., the receding direction) to the devices 205-a, 205-c, and 205-d. As another illustrative example, coordinated driving message for lane changes may be more relevant for sideways and backwards directions (e.g., a message indicating a future maneuver, such as a lane change, may be more relevant in directions that include vehicles in with a possible collision course with the future maneuver).

The device 205-a may be configured to transmit such data packets via the signal 210, which may be an example of a sidelink transmission (e.g., a groupcast message). In some examples, the device 205-a may be configured to transmit the signal 210 omni-directionally. However, such omni-directional communications may result in poor performance in the wireless communications system 200, for example, if the data packet includes information that is relatively more relevant in some directions than other directions. For example, the device 205-a may allocate relatively high power to a TRP transmitting signal 210 in a direction that is less relevant for the signal 210 or the device 205-a may allocate a relatively low power to a TRP transmitting signal 210 in a relatively more relevant direction, which may result in inefficient power usage or a reduced likelihood that a target device 205 may receive the directional information of the data packet.

In accordance with the techniques described herein, the devices 205 may implement directional coverage for data transmissions (e.g., the device 205-a may transmit the signal 210 in a directional manner using one or more indications of directional coverage information from an application layer of the device 205-a). For example, the device 205-a may identify one or more parameters associated with a data packet to be transmitted by the device 205-a. In some examples, a first protocol layer of the device 205-a (e.g., an application layer) may indicate the parameters to a second protocol layer of the device 205-a (e.g., an access layer of the device 205-a). As an illustrative example, an application layer may indicate quality of service (QoS) parameters associated with a data packet (e.g., a range parameter for V₂X groupcast), QoS parameters associated with a data flow (e.g., a resource type, a priority level, a packet delay budget, a packet error rate, etc.), or a combination thereof, among other examples of parameters. The parameters may include directional coverage information associated with the data packet and/or the data flow. For example, the parameters may indicate a direction to transmit the data packet with respect to the direction of motion of the device 205-a (e.g., in the direction of motion, perpendicular to the direction of motion, opposite the direction of motion, or a combination thereof). Additionally or alternatively, the parameters may indicate a direction to transmit the data packet with respect to a frame of reference (e.g., reference directions such as north, east, west, south, or a combination thereof). In some examples, the directional coverage information may include a combination of directions, one or more weighting factors (e.g., each weighting factor indicating a relative importance of a respective direction), or both.

In some examples, the device 205-a may assign the data packet to a data flow (e.g., a QoS flow) based on a mapping between the QoS parameters indicated by the application layer (e.g., including the directionality coverage information) to a set of configured QoS flows (e.g., the device 205-a may select a QoS flow with a different set of parameters in accordance with the mapping). The device 205-a may determine a radio bearer for transmitting the data packet based on the selected data flow. The device 205-a may transmit the data packet in accordance with the parameters. For example, device 205-a may transmit the signal 210 from an access layer of the device 205-a using the parameters indicated by the application layer of the device 205-a (e.g., the coverage area of the signal 210 may be biased in a relatively higher priority direction in accordance with coverage information indicated by the parameters).

In some examples, the device 205-a may identify one or more TRPs (e.g., the device 205-a may select one or more transmit antennas to send the signal 210) and/or a transmit precoder (e.g., a power split over a selected set of transmit antennas) in accordance with the directional coverage information. Such techniques may enable the device 205-a may adjust a shape of the signal 210 (e.g., a coverage area of the signal 210 may be configured to be directional using the parameters). An access layer of the device 205-a may determine one or more TRPs (e.g., one or more transmit antennas of the one or more TRPs) and one or more power parameters for each of the one or more TRPs in order to transmit the signal 210 in accordance with the directional coverage information. As an illustrative example, the coverage area of the signal 210 may be directed more to the device 205-b if the coverage information indicates that the forward direction is relatively more relevant, among other examples of directions and coverage areas.

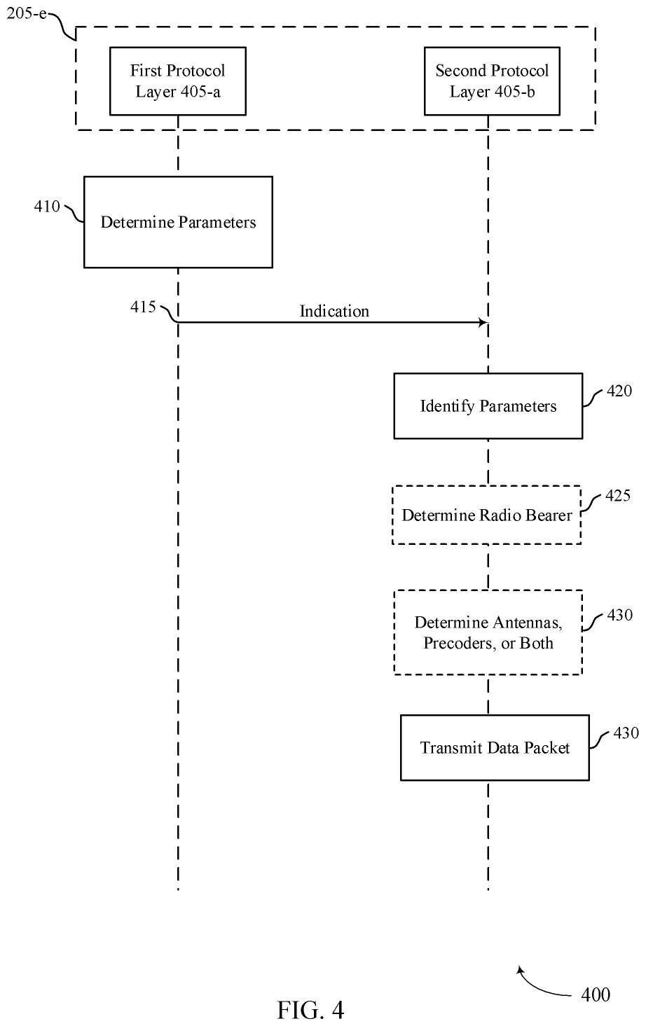

Additionally or alternatively, the device 205-a may send one or more retransmissions of the data packet in accordance with one or more QoS parameters (e.g., the device 205-a may send each retransmission using a respective set of parameters based on the directionality coverage information) as described herein with reference to FIG. 4.

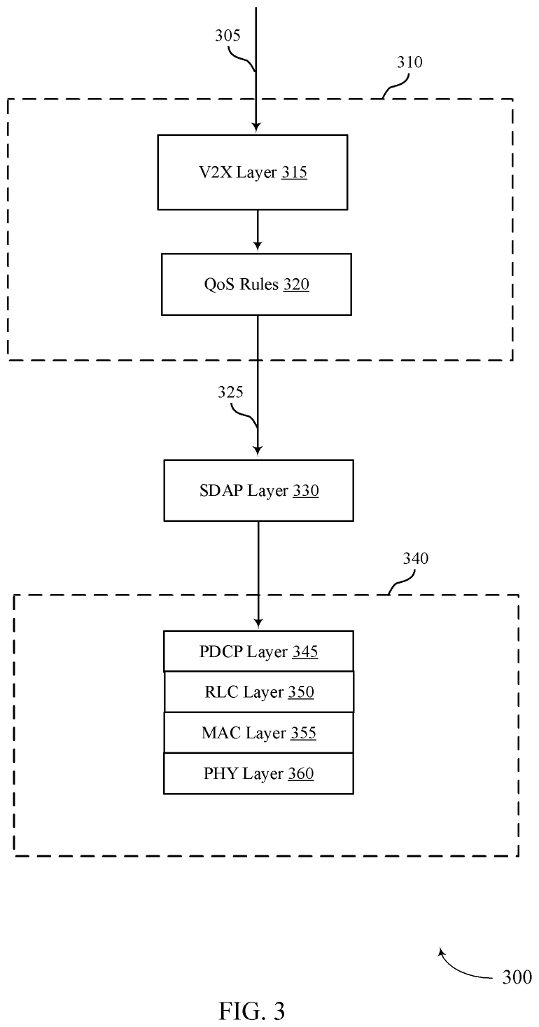

FIG. 3 illustrates an example of a block diagram 300 that supports transmission coverage techniques in accordance with aspects of the present disclosure. In some examples, the block diagram 300 may implement aspects of the wireless communications system 100 or the wireless communications system 200. For example, the block diagram 300 may illustrate inter-layer operations within a wireless device, such as a UE 115 or a device 205 as described with reference to FIGS. 1 and 2, respectively.

The device may generate a data packet 305, which may be an example of a V₂X data packet for V₂X communications. For example, an application of the device may generate information for transmission to other devices (e.g., sensor information, collision indications, or other examples of data included in sidelink messages as described herein). The data packet 305 may be processed by a first protocol layer 310. The first protocol layer 310 may be an example of an application layer of the device. For example, the first protocol layer may include or be an example of aspects of a V₂X layer 315. The first protocol layer 310 may classify and mark PC5 user plane traffic. For instance, the first protocol layer 310 may associate PC5 traffic to QoS flows at the QoS rules 320. Although shown as separate for illustrative clarity, it is to be understood that the QoS rules 320 may be included in the V₂X layer 315.

As an illustrative example, the device may identify one or more QoS parameters requested by the application of the device. The device may assign the data packet 305 to a QoS flow based on the identified parameters. For example, the device may determine a QoS flow that corresponds to the QoS parameters (e.g., the device may be configured with a quantity of QoS flows, each QoS flow corresponding to a respective set of QoS parameters). The device may indicate a QoS flow identifier (ID) to other layers, which may enable the other layers to determine the QoS parameters to use for transmission of the data packet (e.g., the other layers may be configured with a set of QoS parameters for a provided QoS flow ID).

The one or more QoS parameters may include per-flow parameters and/or per-packet parameters. For example, the first protocol layer 310 may indicate a QoS flow ID which may correspond to a set of per-flow QoS parameters, such as a resource type parameter (e.g., an indication of a guaranteed bit rate (GBR), an indication of a delay-critical GFBR, or an indication of a non-GBR resource type, among other examples), a priority level parameter, a packet delay budget parameter, a packet error rate parameter (e.g., an estimated packet error rate), an averaging window (e.g., for GBR and delay-critical GBR resource types), a maximum data burst volume (e.g., for delay-critical GBR resource types), or any combination thereof, among other examples of per-flow QoS parameters. Additionally or alternatively, the first protocol layer 310 may indicate one per-packet QoS parameters (e.g., for dynamic control of individual data packets in a data flow), such as a range parameter (e.g., an indication of a minimum distance that the device may fulfill the QoS parameters), for example, for V₂X groupcast operations.

The first protocol layer 310 may send indication 325 indicating the data packet or the one or more QoS parameters to one or more other layers. For example, the first protocol layer 310 may indicate the one or more QoS parameters (e.g., via a QoS flow ID and/or one or more per-packet QoS parameters) to a second protocol layer 340, which may be an example of an access layer (e.g., a user protocol stack). The service data adaptation protocol (SDAP) layer 330 may map a PC5 QoS flow to a sidelink radio bearer based on the indicated QoS parameters from the first protocol layer 310. Although shown as separate for illustrative clarity, it is to be understood that the SDAP layer 330 may be included in the second protocol layer 340. The SDAP layer 330 may indicate the bearer, the one or more QoS parameters, the data packet, or any combination thereof to other layers. For example, the PDCP layer 345, the RLC layer 350, the MAC layer 355, and/or the physical (PHY) layer 360 may receive the indications and transmit the data packet in accordance with the one or more QoS parameters as described herein.

In accordance with the techniques described herein, the block diagram 300 may support directional coverage information for the transmission of data packets. For example, the first protocol layer 310 (e.g., the application layer) may indicate directional coverage information (e.g., a transmission coverage bias indication) to the second protocol layer 340. In some examples, the directional coverage information may be on a per-flow basis, which may reduce signaling overhead for indicating the parameters. For example, parameters indicating the directional coverage information may correspond to a QoS data flow ID. The access layer may identify the parameters indicating the directional coverage information by determining a set of parameters that correspond to an indicated QoS data flow ID from the application layer. The access layer may utilize the indicated direction coverage information for multiple data packets included in the data flow. Additionally or alternatively, the directional coverage information may be implemented on a per-packet basis. For example, the application layer may send, to the access layer, parameters indicating the direction coverage information for a data packet, which may provide dynamic control of directional coverage for each data packet in a data flow.

The directional coverage information parameters may indicate a direction to transmit the data packet with respect to the direction of motion of the device (e.g., in the direction of motion, perpendicular to the direction of motion, opposite the direction of motion, or a combination thereof). Additionally or alternatively, the parameters may indicate a direction to transmit the data packet with respect to a frame of reference (e.g., reference directions such as north, east, west, south, or a combination thereof). In some examples, the directional coverage information may include a combination of directions, one or more weighting factors (e.g., each weighting factor indicating a relative importance of a respective direction), or both, as described with reference to FIG. 4

The device may transmit the data packet using the parameters indicated by the application layer of the device (e.g., the coverage area of a signal carrying the data packet may be biased in a relatively higher priority direction in accordance with coverage information indicated by the parameters). In some examples, the device may identify one or more TRPs and/or a transmit precoder in accordance with the directional coverage information. Additionally or alternatively, the device may send one or more retransmissions of the data packet in accordance with one or more QoS parameters (e.g., the device may send each retransmission using a respective set of parameters based on the directionality coverage information) as described herein with reference to FIG. 4.

FIG. 4 illustrates an example of a process flow 400 that supports transmission coverage techniques in accordance with aspects of the present disclosure. In some examples, the process flow 400 may implement aspects of the wireless communications system 100 or the wireless communications system 200. For example, the process flow 400 may illustrate operations of protocol layers of a device 205-e, which may be an example of a UE 115 or a device 205 as described with reference to FIGS. 1-3. The device 205-e may include a first protocol layer 405-a and a second protocol layer 405-b, which may be examples of a first protocol layer 310 (e.g., an application layer) and a second protocol layer 340 (e.g., an access layer) as described with reference to FIG. 3.

At 410, the first protocol layer 405-a may determine one or more parameters. For example, the first protocol layer 405-a may receive, from an application of the device 205-e, a data packet for sidelink communications with other device 205. The first protocol layer 405-a may also receive an indication of requested QoS parameters associated with the data packet and/or a data flow that includes the data packet (e.g., the application of the device 205-e may indicate a latency tolerance of the data, a priority level of the data, etc.). In some examples, the first protocol layer 405-a may assign the data packet to a QoS data flow based on a mapping between the requested (e.g., desired) QoS parameters and a set of pre-configured QoS data flows (e.g., each QoS data flow may be configured with a corresponding set of QoS parameters). Thus, the first protocol layer 405-a may determine one or more per-flow parameters (e.g., the set of parameters corresponding to an assigned QoS data flow ID), one or more per-packet parameters (e.g., dynamic parameters corresponding to the data packet), or a combination thereof as described with reference to FIG. 3.

The parameters may include an indication of directional coverage information. For example, one or more per-flow parameters, one or more per-packet parameters, or a combination thereof may include directional coverage information for the data packet, the data flow including the data packet, or both. In some examples, the parameters may indicate a direction to transmit the data packet with respect to the direction of motion of the device 205-e (e.g., in the direction of motion, perpendicular to the direction of motion, opposite the direction of motion, or a combination thereof). For example, the parameters may indicate to transmit to the front of the vehicle (e.g., in the direction of motion), the left or right side of the vehicle, behind the vehicle, or a combination thereof. In some examples, the parameters may indicate a direction to transmit the data packet with respect to a frame of reference (e.g., a global frame of reference). For example, the parameters may indicate reference directions for transmission of the data such as north, east, west, south, or a combination thereof. In some examples, the directional coverage information may include a combination of directions, one or more weighting factors (e.g., each weighting factor indicating a relative importance of a respective direction), or both (e.g., the parameters may indicate a direction and a relative magnitude of the transmission of a signal in that direction). As an illustrative example, the coverage information (e.g., QoS parameters including the coverage information) may indicate to transmit a data packet or data flow in a forward direction with a relative magnitude of 1.0, a backward direction with a relative magnitude of 0.2, a left side direction with a relative magnitude of 0.1, a right side direction with a relative magnitude of 0.2, among other examples of direction indications and weighting factors.

At 415, the first protocol layer 405-a may send an indication to the second protocol layer 405-b. The indication may indicate the data packet and the determined parameters. For example, the first protocol layer 405-a may assign a data packet or data flow to a QoS data flow ID based on a mapping between the requested parameters and a set of configured QoS data flows. The indication may indicate the QoS data flow ID to the second protocol layer 405-b. Additionally or alternatively, the indication may include one or more per-packet parameters (e.g., a range parameter and/or direction coverage information parameters).

At 420, the second protocol layer 405-b may identify one or more parameters. For example, the second protocol layer 405-b may receive the indication 415 and may identify QoS parameters for transmission of a data packet using the indication 415 (e.g., the second protocol layer 405-b may use a pre-configured set of parameters associated with an indicated QoS data flow, the indication may include one or more parameters such as directional coverage information parameters, etc.). The second protocol layer 405-b may determine directional coverage information for transmission of data using the identified parameters. For example, the second protocol layer may identify one or more directions for transmitting a data packet or a data flow (e.g., the parameters may indicate one or more directions, weighting factors, or both).

In some examples, at 425 the second protocol layer 405-b may determine a radio bearer for communicating the data. For example, the second protocol layer 405-b may map an assigned QoS data flow to a sidelink radio bearer that satisfies the QoS parameters associated with the QoS data flow. Thus, the second protocol layer 405-b may determine the radio bearer based on the mapping and communicate the data via the determined radio bearer.

In some examples, at 430 the second protocol layer 405-b may determine antennas, precoders, or both. For example, the second protocol layer 405-b may identify one or more TRPs for transmitting the signal in accordance with the QoS parameters. As an illustrative example, the QoS parameters may include directional coverage information indicating to transmit the data packet in a forward direction with relatively more strength than a backwards direction (e.g., such that the shape of the coverage area of the transmission is relatively larger towards the forward direction compared to the backwards direction). The second protocol layer 405-b may select a TRP located in the indicated direction (e.g., a TRP on the front of the vehicle), which may result in the coverage area of the transmission being directionally biased in the direction. Additionally or alternatively, the second protocol layer 405-b may select a subset of transmit antennas (e.g., TRPs) for transmission of the data. For example, the second protocol layer 405-b may select multiple transmit antennas and determine a transmit precoder in order to directionally bias the coverage area of the transmission in accordance with the directional coverage information. The second protocol layer 405-b may allocate power to each transmit antenna to obtain the indicated directional coverage. As an illustrative example, a power split between a front antenna and a back antenna may be allocated with more power to the front antenna if the front direction is weighted more heavily than the back direction, among other examples of directions and precoders. Such techniques may result in one or more advantages. For example, selecting transmit antennas and/or power parameters (e.g., power allocations in accordance with a precoder) may achieve more transmission coverage towards a relatively more relevant direction, reduce inefficient power usage a relatively less relevant direction, or both, among other advantages.

At 430, the second protocol layer 405-b may transmit the data packet in accordance with the parameters. For example, the data packet may be transmitted using the determined radio bearer associated with the set of QoS parameters, the determined TRPs and precoder (e.g., power split between antennas) that satisfy the directional coverage information of the parameters, etc.

Additionally or alternatively, the device 205-e may send one or more retransmissions of the data packet in accordance with one or more QoS parameters. For example, the device 205-e may determine a quantity of retransmissions for a data packet (e.g., the data packet may be transmitted 3 times in accordance with one or more QoS parameters). The device 205-e may identify a respective set of parameters for each transmission of the data based on the QoS parameters (e.g., the set of QoS parameters may be selected for each transmission in accordance with the desired directionality coverage information). As an illustrative example, the QoS parameters may indicate a first direction (e.g., a forward direction, a north direction, etc.) weighting factor of 1.0 and a second direction (e.g., a backward direction, a south direction, etc.) weighting factor of 0.2. The device 205-e may identify a respective set of TRPs and/or parameters for each retransmission. For example, the device 205-e may transmit a first transmission of the data using a front TRP, a second transmission of the data using the front TRP, and a third transmission of the data using the back TRP. Additionally or alternatively, the device 205-e may use a different precoder (e.g., power allocation) for each transmission via multiple transmit antennas, such that an aggregate coverage area of all the retransmissions satisfies the indicated QoS parameters (e.g., the aggregate shape of the retransmission signals satisfies the indicated directions and weighting factors).

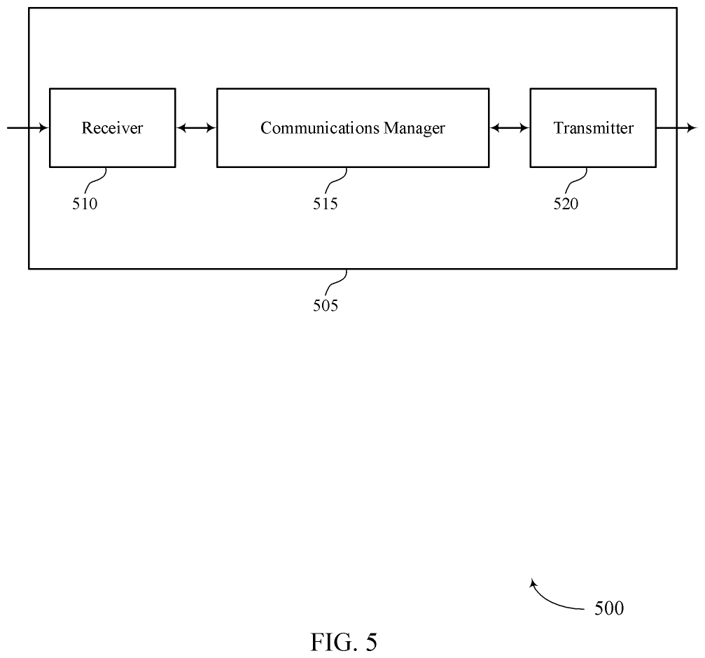

FIG. 5 shows a block diagram 500 of a device 505 that supports transmission coverage techniques in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

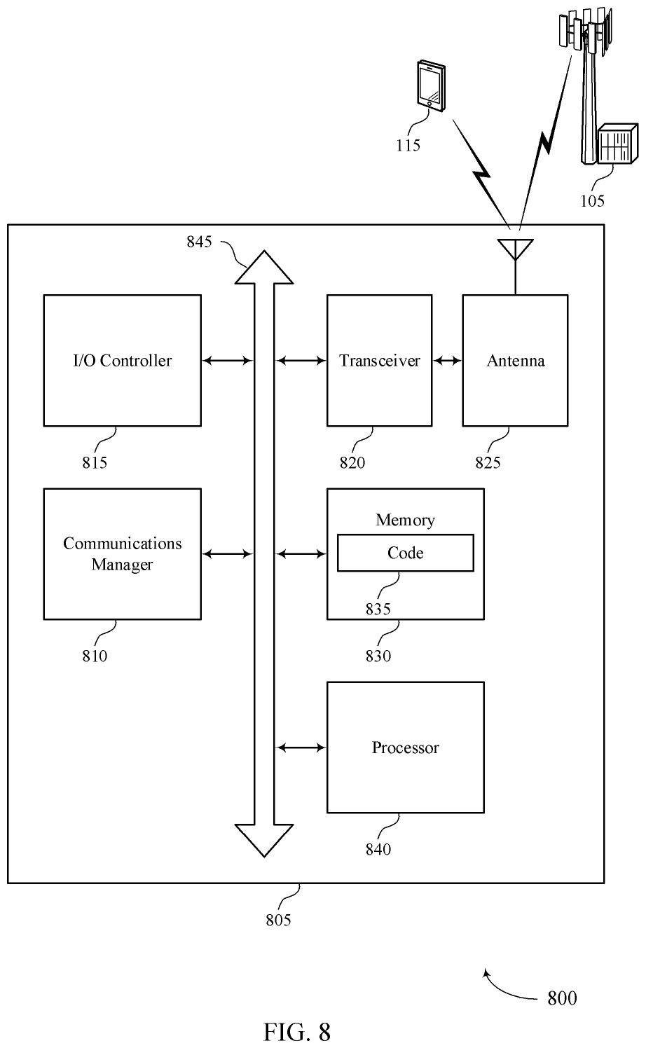

The receiver 510 may receive information such as packets, user data, or control information associated with various information channels (e.g., control channels, data channels, and information related to transmission coverage techniques, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may receive, at a second protocol layer of the UE and from a first protocol layer of the UE, the second protocol layer being lower than the first protocol layer, an indication of one or more quality of service parameters associated with a data packet to be transmitted by the UE, identify, from the one or more quality of service parameters, directional coverage information associated with the data packet, the directional coverage information indicative of one or more transmission directions in which the data packet is to be transmitted, and transmit the data packet in accordance with at least the directional coverage information of the one or more quality of service parameters. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The communications manager 515 as described herein may be implemented to realize one or more potential advantages at the device 505, a processor of the device 505, a communications system including the device 505, or a combination thereof. One implementation may allow the device 505 to directionally bias transmission coverage area of a data packet in accordance with QoS parameters, as described herein. Such techniques may result in improved communications efficiency, reduced power usage, or both, among other advantages.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

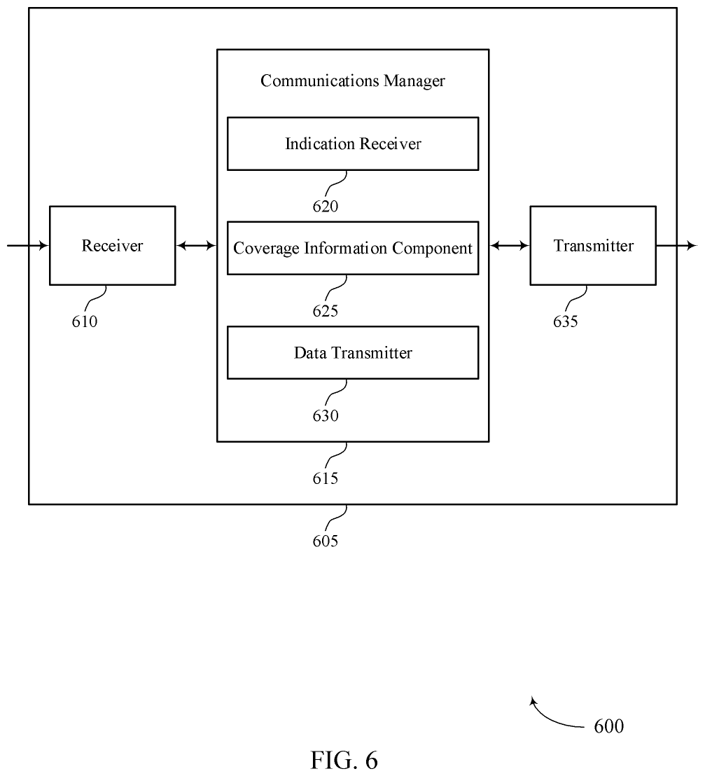

FIG. 6 shows a block diagram 600 of a device 605 that supports transmission coverage techniques in accordance with aspects of the present disclosure. The device 605 may be an example of aspects of a device 505, or a UE 115 as described herein. The device 605 may include a receiver 610, a communications manager 615, and a transmitter 635. The device 605 may also include a processor. Each of these components may be in communication with one another (e.g., via one or more buses).

The receiver 610 may receive information such as packets, user data, or control information associated with various information channels (e.g., control channels, data channels, and information related to transmission coverage techniques, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include an indication receiver 620, a coverage information component 625, and a data transmitter 630. The communications manager 615 may be an example of aspects of the communications manager 810 described herein.

The indication receiver 620 may receive, at a second protocol layer of the UE and from a first protocol layer of the UE, the second protocol layer being lower than the first protocol layer, an indication of one or more quality of service parameters associated with a data packet to be transmitted by the UE.

The coverage information component 625 may identify, from the one or more quality of service parameters, directional coverage information associated with the data packet, the directional coverage information indicative of one or more transmission directions in which the data packet is to be transmitted.

The data transmitter 630 may transmit the data packet in accordance with at least the directional coverage information of the one or more quality of service parameters.

The transmitter 635 may transmit signals generated by other components of the device 605. In some examples, the transmitter 635 may be collocated with a receiver 610 in a transceiver module. For example, the transmitter 635 may be an example of aspects of the transceiver 820 described with reference to FIG. 8. The transmitter 635 may utilize a single antenna or a set of antennas.

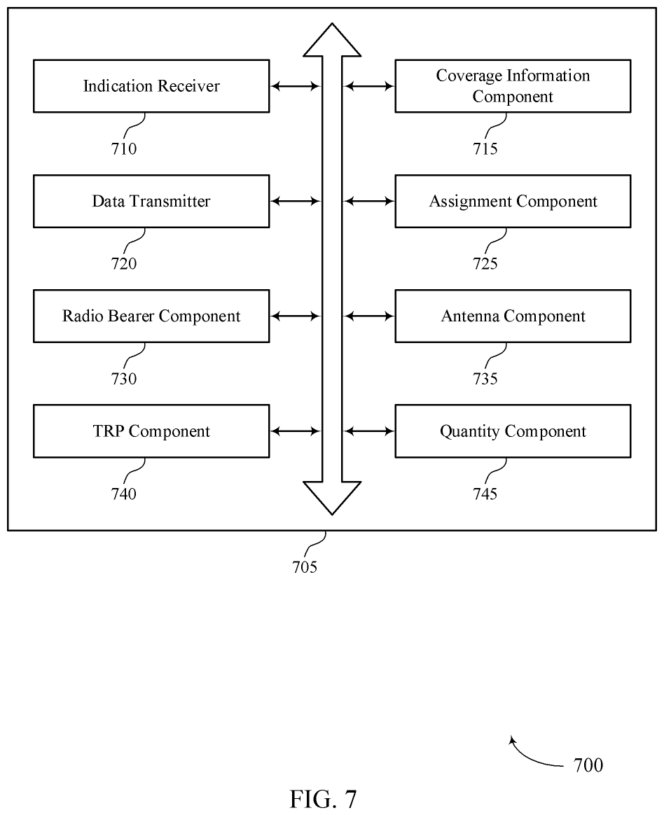

FIG. 7 shows a block diagram 700 of a communications manager 705 that supports transmission coverage techniques in accordance with aspects of the present disclosure. The communications manager 705 may be an example of aspects of a communications manager 515, a communications manager 615, or a communications manager 810 described herein. The communications manager 705 may include an indication receiver 710, a coverage information component 715, a data transmitter 720, an assignment component 725, a radio bearer component 730, an antenna component 735, a TRP component 740, and a quantity component 745. Each of these modules may communicate, directly or indirectly, with one another (e.g., via one or more buses).

The indication receiver 710 may receive, at a second protocol layer of the UE and from a first protocol layer of the UE, the second protocol layer being lower than the first protocol layer, an indication of one or more quality of service parameters associated with a data packet to be transmitted by the UE. In some cases, the UE includes a vehicle, the first protocol layer includes an application layer, the second protocol layer includes an access layer, or any combination thereof.

The coverage information component 715 may identify, from the one or more quality of service parameters, directional coverage information associated with the data packet, the directional coverage information indicative of one or more transmission directions in which the data packet is to be transmitted. In some examples, the coverage information component 715 may identify a direction for transmitting the data packet relative to a direction of motion of the UE. In some examples, the coverage information component 715 may identify a direction for transmitting the data packet relative to one or more reference directions. In some examples, the coverage information component 715 may identify a set of directions including a direction for transmitting the data packet, and one or more weighting factors corresponding to each direction of the set of directions.

In some examples, the coverage information component 715 may identify the directional coverage information on a per packet basis. In some examples, the coverage information component 715 may identify the directional coverage information on a per data flow basis.

The data transmitter 720 may transmit the data packet in accordance with at least the directional coverage information of the one or more quality of service parameters. In some examples, the data transmitter 720 may transmit a set of transmissions of the data packet.

The assignment component 725 may assign the data packet to a quality of service flow based on a mapping between the one or more quality of service parameters and a set of quality of service flows including the quality of service flow, the set of quality of service flows corresponding to different quality of service parameters.

The radio bearer component 730 may select a radio bearer for transmitting the data packet based on assigning the data packet to the quality of service flow.

The antenna component 735 may identify one or more transmit antennas, a transmit precoder, or both based on the directional coverage information. In some examples, the antenna component 735 may identify one or more antennas, a transmit precoder, or both for each transmission of the set of transmissions based on the directional coverage information. In some examples, the data transmitter 720 may transmit a first transmission of the set of transmissions of the data packet in accordance with a first set of the one or more antennas, a first transmit precoder, or both. In some examples, the data transmitter 720 may transmit a second transmission of the set of transmissions of the data packet in accordance with a second set of the one or more antennas, a second transmit precoder, or both.

In some cases, the transmit precoder is associated with a power allocation to the one or more transmit antennas. In some examples, the data transmitter 720 may transmit the data packet using the identified one or more transmit antennas, the transmit precoder, or both.

The TRP component 740 may select one or more transmission reception points of the UE in accordance with the directional coverage information, where transmitting the data packet is based on selecting the one or more transmission reception points.

The quantity component 745 may identify a quantity of the set of transmissions based on the one or more quality of service parameters.

FIG. 8 shows a diagram of a system 800 including a device 805 that supports transmission coverage techniques in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may receive, at a second protocol layer of the UE and from a first protocol layer of the UE, the second protocol layer being lower than the first protocol layer, an indication of one or more quality of service parameters associated with a data packet to be transmitted by the UE, identify, from the one or more quality of service parameters, directional coverage information associated with the data packet, the directional coverage information indicative of one or more transmission directions in which the data packet is to be transmitted, and transmit the data packet in accordance with at least the directional coverage information of the one or more quality of service parameters.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include random-access memory (RAM) and read-only memory (ROM). The memory 830 may store computer-readable, computer-executable code 835 including instructions that, when executed, cause the processor to perform various functions described herein. In some cases, the memory 830 may contain, among other things, a basic input/output system (BIOS) which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting transmission coverage techniques).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

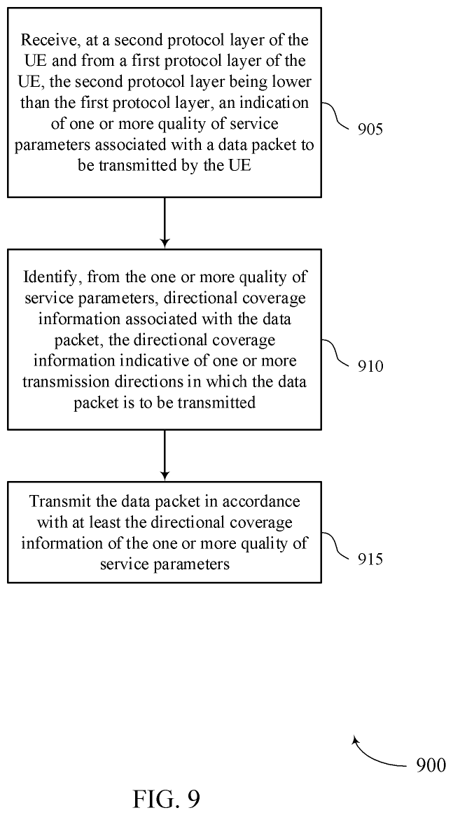

FIG. 9 shows a flowchart illustrating a method 900 that supports transmission coverage techniques in accordance with aspects of the present disclosure. The operations of method 900 may be implemented by a UE 115 or its components as described herein. For example, the operations of method 900 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 905, the UE may receive, at a second protocol layer of the UE and from a first protocol layer of the UE, the second protocol layer being lower than the first protocol layer, an indication of one or more quality of service parameters associated with a data packet to be transmitted by the UE. The operations of 905 may be performed according to the methods described herein. In some examples, aspects of the operations of 905 may be performed by an indication receiver as described with reference to FIGS. 5 through 8.

At 910, the UE may identify, from the one or more quality of service parameters, directional coverage information associated with the data packet, the directional coverage information indicative of one or more transmission directions in which the data packet is to be transmitted. The operations of 910 may be performed according to the methods described herein. In some examples, aspects of the operations of 910 may be performed by a coverage information component as described with reference to FIGS. 5 through 8.

At 915, the UE may transmit the data packet in accordance with at least the directional coverage information of the one or more quality of service parameters. The operations of 915 may be performed according to the methods described herein. In some examples, aspects of the operations of 915 may be performed by a data transmitter as described with reference to FIGS. 5 through 8.

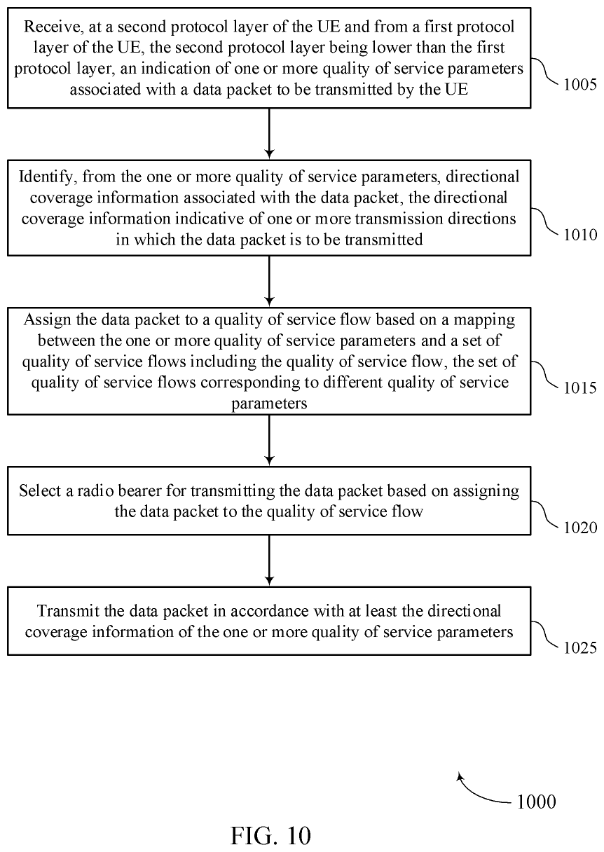

FIG. 10 shows a flowchart illustrating a method 1000 that supports transmission coverage techniques in accordance with aspects of the present disclosure. The operations of method 1000 may be implemented by a UE 115 or its components as described herein. For example, the operations of method 1000 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1005, the UE may receive, at a second protocol layer of the UE and from a first protocol layer of the UE, the second protocol layer being lower than the first protocol layer, an indication of one or more quality of service parameters associated with a data packet to be transmitted by the UE. The operations of 1005 may be performed according to the methods described herein. In some examples, aspects of the operations of 1005 may be performed by an indication receiver as described with reference to FIGS. 5 through 8.

At 1010, the UE may identify, from the one or more quality of service parameters, directional coverage information associated with the data packet, the directional coverage information indicative of one or more transmission directions in which the data packet is to be transmitted. The operations of 1010 may be performed according to the methods described herein. In some examples, aspects of the operations of 1010 may be performed by a coverage information component as described with reference to FIGS. 5 through 8.

At 1015, the UE may assign the data packet to a quality of service flow based on a mapping between the one or more quality of service parameters and a set of quality of service flows including the quality of service flow, the set of quality of service flows corresponding to different quality of service parameters. The operations of 1015 may be performed according to the methods described herein. In some examples, aspects of the operations of 1015 may be performed by an assignment component as described with reference to FIGS. 5 through 8.

At 1020, the UE may select a radio bearer for transmitting the data packet based on assigning the data packet to the quality of service flow. The operations of 1020 may be performed according to the methods described herein. In some examples, aspects of the operations of 1020 may be performed by a radio bearer component as described with reference to FIGS. 5 through 8.

At 1025, the UE may transmit the data packet in accordance with at least the directional coverage information of the one or more quality of service parameters. The operations of 1025 may be performed according to the methods described herein. In some examples, aspects of the operations of 1025 may be performed by a data transmitter as described with reference to FIGS. 5 through 8.

It should be noted that the methods described herein describe possible implementations, and that the operations and the steps may be rearranged or otherwise modified and that other implementations are possible. Further, aspects from two or more of the methods may be combined.

The following provides an overview of examples of the present disclosure:

Example 1: A method for wireless communications at a UE, comprising: receiving, at a second protocol layer of the UE and from a first protocol layer of the UE, the second protocol layer being lower than the first protocol layer, an indication of one or more quality of service parameters associated with a data packet to be transmitted by the UE; identifying, from the one or more quality of service parameters, directional coverage information associated with the data packet, the directional coverage information indicative of one or more transmission directions in which the data packet is to be transmitted; and transmitting the data packet in accordance with at least the directional coverage information of the one or more quality of service parameters.

Example 2: The method of example 1, wherein identifying the directional coverage information comprises: identifying a direction for transmitting the data packet relative to a direction of motion of the UE.

Example 3: The method of examples 1 or 2, wherein identifying the directional coverage information comprises: identifying a direction for transmitting the data packet relative to one or more reference directions.

Example 4: The method of any one of examples 1 through 3, wherein identifying the directional coverage information comprises: identifying a set of directions including a direction for transmitting the data packet, and one or more weighting factors corresponding to each direction of the set of directions.

Example 5: The method of any one of examples 1 through 4, wherein identifying the directional coverage information comprises: identifying the directional coverage information on a per packet basis.

Example 6: The method of any one of examples 1 through 5, wherein identifying the directional coverage information comprises: identifying the directional coverage information on a per data flow basis.

Example 7: The method of any one of examples 1 through 6, further comprising: assigning the data packet to a quality of service flow based at least in part on a mapping between the one or more quality of service parameters and a set of quality of service flows including the quality of service flow, the set of quality of service flows corresponding to different quality of service parameters; and selecting a radio bearer for transmitting the data packet based at least in part on assigning the data packet to the quality of service flow.

Example 8: The method of any one of wherein transmitting the data packet comprises: identifying one or more transmit antennas, a transmit precoder, or both based at least in part on the directional coverage information; and transmitting the data packet using the identified one or more transmit antennas, the transmit precoder, or both.

Example 9: The method of any one of examples 1 through 8, wherein the transmit precoder is associated with a power allocation to the one or more transmit antennas.

Example 10: The method of any one of examples 1 through 9, further comprising: selecting one or more transmission reception points of the UE in accordance with the directional coverage information, wherein transmitting the data packet is based at least in part on selecting the one or more transmission reception points.

Example 11: The method of any one of examples 1 through 10, wherein transmitting the data packet comprises: transmitting a plurality of transmissions of the data packet.

Example 12: The method of any one of examples 1 through 11, further comprising: identifying a quantity of the plurality of transmissions based at least in part on the one or more quality of service parameters.

Example 13: The method of any one of examples 1 through 12, further comprising: identifying one or more antennas, a transmit precoder, or both for each transmission of the plurality of transmissions based at least in part on the directional coverage information.

Example 14: The method of any one of examples 1 through 13, further comprising: transmitting a first transmission of the plurality of transmissions of the data packet in accordance with a first set of the one or more antennas, a first transmit precoder, or both; and transmitting a second transmission of the plurality of transmissions of the data packet in accordance with a second set of the one or more antennas, a second transmit precoder, or both.

Example 15: The method of any one of examples 1 through 14, wherein the UE comprises a vehicle, the first protocol layer comprises an application layer, the second protocol layer comprises an access layer, or any combination thereof.

Example 16: An apparatus for wireless communication comprising at least one means for performing a method of any one of examples 1 through 15.

Example 17: An apparatus for wireless communication comprising a processor and memory coupled to the processor, the processor and memory configured to perform a method of any one of examples 1 through 15.

Example 18: A non-transitory computer-readable medium storing code for wireless communication, the code comprising instructions executable by a processor to perform a method of any one of examples 1 through 15.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communications at a user equipment (UE), comprising:
receiving, at a second protocol layer of the UE and from a first protocol layer of the UE, the second protocol layer being lower than the first protocol layer, an indication of one or more quality of service parameters associated with a data packet to be transmitted by the UE;
identifying, from the one or more quality of service parameters, directional coverage information associated with the data packet, the directional coverage information indicative of one or more transmission directions in which the data packet is to be transmitted; and
transmitting the data packet in accordance with at least the directional coverage information of the one or more quality of service parameters.

2. The method of claim 1, wherein identifying the directional coverage information comprises:
identifying a direction for transmitting the data packet relative to a direction of motion of the UE.

3. The method of claim 1, wherein identifying the directional coverage information comprises:
identifying a direction for transmitting the data packet relative to one or more reference directions.

4. The method of claim 1, wherein identifying the directional coverage information comprises:
identifying a set of directions including a direction for transmitting the data packet, and one or more weighting factors corresponding to each direction of the set of directions.

5. The method of claim 1, wherein identifying the directional coverage information comprises:
identifying the directional coverage information on a per packet basis.

6. The method of claim 1, wherein identifying the directional coverage information comprises:
identifying the directional coverage information on a per data flow basis.

7. The method of claim 1, further comprising:
assigning the data packet to a quality of service flow based at least in part on a mapping between the one or more quality of service parameters and a set of quality of service flows including the quality of service flow, the set of quality of service flows corresponding to different quality of service parameters; and
selecting a radio bearer for transmitting the data packet based at least in part on assigning the data packet to the quality of service flow.

8. The method of claim 1, wherein transmitting the data packet comprises:
identifying one or more transmit antennas, a transmit precoder, or both based at least in part on the directional coverage information; and
transmitting the data packet using the identified one or more transmit antennas, the transmit precoder, or both.

9. The method of claim 8, wherein the transmit precoder is associated with a power allocation to the one or more transmit antennas.

10. The method of claim 1, further comprising:
selecting one or more transmission reception points of the UE in accordance with the directional coverage information, wherein transmitting the data packet is based at least in part on selecting the one or more transmission reception points.

11. The method of claim 1, wherein transmitting the data packet comprises:
transmitting a plurality of transmissions of the data packet.

12. The method of claim 11, further comprising:
identifying a quantity of the plurality of transmissions based at least in part on the one or more quality of service parameters.

13. The method of claim 11, further comprising:
identifying one or more antennas, a transmit precoder, or both for each transmission of the plurality of transmissions based at least in part on the directional coverage information.

14. The method of claim 13, further comprising:
transmitting a first transmission of the plurality of transmissions of the data packet in accordance with a first set of the one or more antennas, a first transmit precoder, or both; and
transmitting a second transmission of the plurality of transmissions of the data packet in accordance with a second set of the one or more antennas, a second transmit precoder, or both.

15. The method of claim 1, wherein the UE comprises a vehicle, the first protocol layer comprises an application layer, the second protocol layer comprises an access layer, or any combination thereof.

16. An apparatus for wireless communications at a user equipment (UE), comprising:
a processor,
memory coupled with the processor; and
instructions stored in the memory and executable by the processor to cause the apparatus to:
receive, at a second protocol layer of the UE and from a first protocol layer of the UE, the second protocol layer being lower than the first protocol layer, an indication of one or more quality of service parameters associated with a data packet to be transmitted by the UE;
identify, from the one or more quality of service parameters, directional coverage information associated with the data packet, the directional coverage information indicative of one or more transmission directions in which the data packet is to be transmitted; and
transmit the data packet in accordance with at least the directional coverage information of the one or more quality of service parameters.

17. The apparatus of claim 16, wherein the instructions to identify the directional coverage information are executable by the processor to cause the apparatus to:
identify a direction for transmitting the data packet relative to a direction of motion of the UE.

18. The apparatus of claim 16, wherein the instructions to identify the directional coverage information are executable by the processor to cause the apparatus to:
identify a direction for transmitting the data packet relative to one or more reference directions.

19. The apparatus of claim 16, wherein the instructions to identify the directional coverage information are executable by the processor to cause the apparatus to:
identify a set of directions including a direction for transmitting the data packet, and one or more weighting factors corresponding to each direction of the set of directions.

20. The apparatus of claim 16, wherein the instructions to identify the directional coverage information are executable by the processor to cause the apparatus to:
identify the directional coverage information on a per packet basis.

21. The apparatus of claim 16, wherein the instructions to identify the directional coverage information are executable by the processor to cause the apparatus to:
identify the directional coverage information on a per data flow basis.

22. The apparatus of claim 16, wherein the instructions are further executable by the processor to cause the apparatus to:
assign the data packet to a quality of service flow based at least in part on a mapping between the one or more quality of service parameters and a set of quality of service flows including the quality of service flow, the set of quality of service flows corresponding to different quality of service parameters; and
select a radio bearer for transmitting the data packet based at least in part on assigning the data packet to the quality of service flow.

23. The apparatus of claim 16, wherein the instructions to transmit the data packet are executable by the processor to cause the apparatus to:
identify one or more transmit antennas, a transmit precoder, or both based at least in part on the directional coverage information; and
transmit the data packet using the identified one or more transmit antennas, the transmit precoder, or both.

24. The apparatus of claim 23, wherein the transmit precoder is associated with a power allocation to the one or more transmit antennas.

25. The apparatus of claim 16, wherein the instructions are further executable by the processor to cause the apparatus to:
select one or more transmission reception points of the UE in accordance with the directional coverage information, wherein transmitting the data packet is based at least in part on selecting the one or more transmission reception points.

26. The apparatus of claim 16, wherein the instructions to transmit the data packet are executable by the processor to cause the apparatus to:
transmit a plurality of transmissions of the data packet.

27. The apparatus of claim 26, wherein the instructions are further executable by the processor to cause the apparatus to:
identify a quantity of the plurality of transmissions based at least in part on the one or more quality of service parameters.

28. The apparatus of claim 26, wherein the instructions are further executable by the processor to cause the apparatus to:
identify one or more antennas, a transmit precoder, or both for each transmission of the plurality of transmissions based at least in part on the directional coverage information.

29. The apparatus of claim 28, wherein the instructions are further executable by the processor to cause the apparatus to:
transmit a first transmission of the plurality of transmissions of the data packet in accordance with a first set of the one or more antennas, a first transmit precoder, or both; and
transmit a second transmission of the plurality of transmissions of the data packet in accordance with a second set of the one or more antennas, a second transmit precoder, or both.

30. The apparatus of claim 16, wherein the UE comprises a vehicle, the first protocol layer comprises an application layer, the second protocol layer comprises an access layer, or any combination thereof.

31. An apparatus for wireless communications at a user equipment (UE), comprising:
means for receiving, at a second protocol layer of the UE and from a first protocol layer of the UE, the second protocol layer being lower than the first protocol layer, an indication of one or more quality of service parameters associated with a data packet to be transmitted by the UE;
means for identifying, from the one or more quality of service parameters, directional coverage information associated with the data packet, the directional coverage information indicative of one or more transmission directions in which the data packet is to be transmitted; and
means for transmitting the data packet in accordance with at least the directional coverage information of the one or more quality of service parameters.

32. The apparatus of claim 31, wherein the means for identifying the directional coverage information comprises:
means for identifying a direction for transmitting the data packet relative to a direction of motion of the UE.

33. The apparatus of claim 31, wherein the means for identifying the directional coverage information comprises:
means for identifying a direction for transmitting the data packet relative to one or more reference directions.

34.-45. (canceled)

46. A non-transitory computer-readable medium storing code for wireless communications at a user equipment (UE), the code comprising instructions executable by a processor to:
receive, at a second protocol layer of the UE and from a first protocol layer of the UE, the second protocol layer being lower than the first protocol layer, an indication of one or more quality of service parameters associated with a data packet to be transmitted by the UE;
identify, from the one or more quality of service parameters, directional coverage information associated with the data packet, the directional coverage information indicative of one or more transmission directions in which the data packet is to be transmitted; and
transmit the data packet in accordance with at least the directional coverage information of the one or more quality of service parameters.

47.-48. (canceled)

49. The non-transitory computer-readable medium of claim 46, wherein the instructions to identify the directional coverage information are executable to:
identify a set of directions including a direction for transmitting the data packet, and one or more weighting factors corresponding to each direction of the set of directions.

50.-60. (canceled)
